(19) United States
(12) Patent Application Publication
(10) Pub. No.: US 2012/0039357 A1
(43) Pub. Date: Feb. 16, 2012

(54) FIBER-OPTIC TEMPERATURE SENSOR ASSEMBLY

(76) Inventors: Marc LEVESQUE, Saint-Augustin-de-Desmaures (CA); Patrick Paradis, Quebec (CA)

(21) Appl. No.: 12/856,887

(22) Filed: Aug. 16, 2010

(51) Int. Cl. G01K 11/32; B29C 57/10

(52) U.S. Cl. 374/159; 156/146; 374/E11.015

(57) ABSTRACT

A fiber-optic temperature sensor assembly comprises a cap with an inner cavity. A sensor substance is received loosely in the inner cavity of the cap, the sensor substance having light-emitting properties adapted to change with specific temperature variations. An optical fiber has a first end received in the inner cavity of the cap and fusion spliced thereto, and a second end of the optical fiber being adapted to be connected to a processing unit for transmitting light signals from the sensor substance to the processing unit when the fiber-optic temperature sensor assembly is subjected to specific temperatures. A method for manufacturing the fiber-optic temperature sensor assembly is defined.

### FIELD OF THE APPLICATION

The present application relates to temperature sensors, and more particularly to a fiber-optic temperature sensor assembly.

### BACKGROUND OF THE ART

Fiber-optic temperature sensors are commonly used in given applications as an advantageous alternative to thermocouples and the like. Fiber-optic temperature sensors are immune to electromagnetic interference (EMI)/radio-frequency interference (RFI). Moreover, fiber-optic temperature sensors are relatively small, and can withstand hazardous environments, including relatively extreme temperatures.

Fiber-optic temperature sensors have an optical fiber extending from a processing unit to the measurement location. A sensor member (e.g., a semiconductor sensor) is provided at an end of the optical fiber. Present fiber-optic temperature sensors use an adhesive or solder to connect the sensor member to the end of the optical fiber.

However, the presence of an adhesive limits the uses of the fiber-optic temperature sensors. For instance, the range of temperature to which the fiber-optic temperature sensor may be exposed is reduced by the reaction of the adhesive to higher temperatures. Also, the strength of the connection between the sensor member and the optical fiber is not optimal. There also have been some shortcomings in uniformly producing fiber-optic temperature sensors of suitable strength at the fiber/sensor member connection. These problems affect the reliability of current fiber-optic temperature sensors. Unreliable temperature sensors are impractical in constraining environments (e.g., nuclear power plants), or concealed systems (e.g., industrial transformers).

### SUMMARY OF THE APPLICATION

It is therefore an aim of the present application to provide a fiber-optic temperature sensor assembly that addresses issues associated with the prior art.

Therefore, in accordance with the present application, there is provided a fiber-optic temperature sensor assembly comprising: a glass cap with an inner cavity; a sensor substance received loosely in the inner cavity of the cap, the sensor substance having light-producing properties adapted to change with specific temperature variations; and a glass optical fiber having a first end received in the inner cavity of the cap and fused without adhesive to the cap, and a second end of the optical fiber being adapted to be connected to a processing unit for transmitting light signals from the sensor substance to the processing unit when the fiber-optic temperature sensor assembly is subjected to specific temperatures.

Further in accordance with the present application, there is provided a method for manufacturing a fiber-optic temperature sensor assembly comprising: fusing without adhesive a first end of a glass cap having an inner cavity to an end of a glass optical fiber; inserting a sensor substance having light-emitting properties adapted to change with temperature variations into the inner cavity of the cap; and closing a second end of the cap to seal the sensor substance in the inner cavity of the cap.

### BRIEF DESCRIPTION OF THE DRAWINGS

FIG. 1 is a schematic sectional view of a fiber-optic temperature sensor assembly in accordance with a first embodiment of the present disclosure;

FIG. 2A is a schematic sectional view of a cap and optical fiber of the fiber-optic temperature assembly of FIG. 1, prior to assembly;

FIG. 2B is a schematic sectional view of the cap of FIG. 2A, with the optical fiber connected to an end of the cap;

FIG. 2C is a schematic sectional view of the cap and optical fiber assembly of FIG. 2B with a sensor substance being inserted in the cap; and

FIG. 2D is a schematic sectional view of the fiber-optic temperature sensor assembly with a second end of the cap being closed.

### DESCRIPTION OF THE PREFERRED EMBODIMENTS

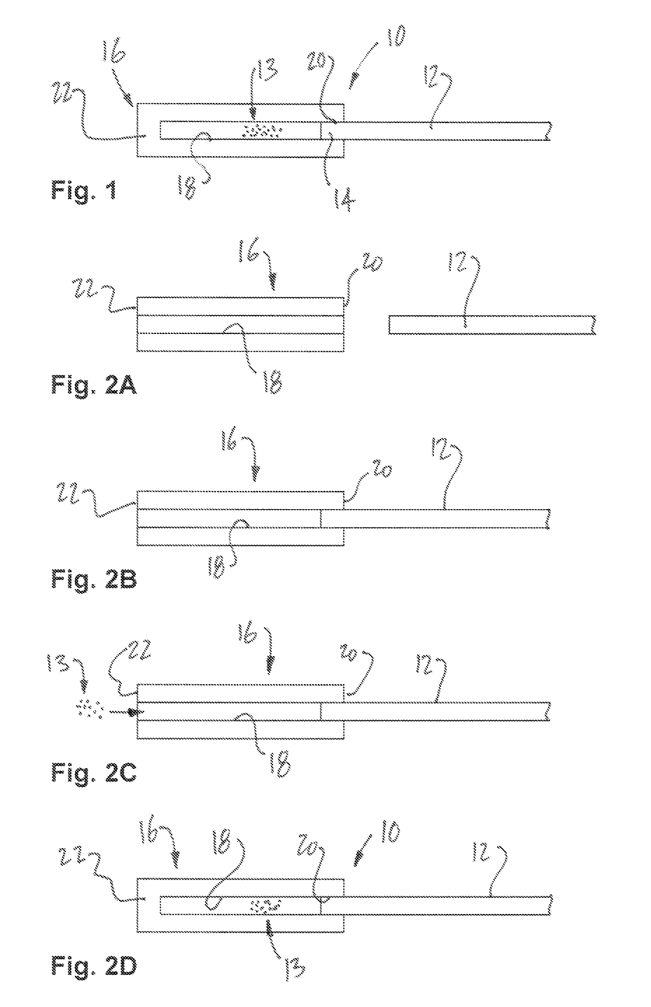

Referring to the drawings and more particularly to FIG. 1, a fiber-optic temperature sensor assembly in accordance with a first embodiment is generally shown at 10. The fiber-optic temperature sensor assembly (hereinafter temperature sensor assembly) is of the type having an optical fiber 12 connected to a processing unit (not shown), with a sensor substance 13 being provided at the sensor end 14 of the optical fiber 12 as accommodated in a cap 16. The optical fiber 12 may consist of a micro-structured optical fiber, or any other suitable type of optical fiber.

The sensor substance 13 may be of the type producing a light signal as a function of the temperature, which light signal is transmitted to the processing unit through the optical fiber 12. In an embodiment, the sensor substance 13 transforms an excitation signal received from a source connected to the optical fiber 12, into light of different characteristics, such as a modified wavelength (e.g., fluorescent substance). According to an embodiment, the sensor substance 13 is typically a fluorophore in a granular or powdery state, loosely received in the inner cavity 18 of the cap 16. When referring to the sensor substance 13 received loosely, it is understood that the sensor substance 13 is simply deposited in the inner cavity 18. The sensor substance may subsequently be restricted from moving in the inner cavity 18 by the insertion of the optical fiber 12 or the closing of the inner cavity 18. For instance, the fluorophore may be fluorogermanate (Mg4FGeO6:Mn) for given applications, with the granular size being within selected ranges. As an alternative, the fluorophore may be LuPO4:Dy, among other possibilities. Fluorogermanate may be used for applications ranging between −260° C. to 725° C. LuPO4:Dy may be used as sensor substance 13 for higher temperature measurements, for instance up to 1500° C.

Other sensor substances 13 may be used as well, for instance substances having a light-absorption spectrum variable as a function of the temperature, or substances whose birefringence varies as function of the temperature.

The cap 16 defines an inner cavity 18, in which the sensor substance 13 is received. A first end 20 of the cap 16 receives the sensor end 14 of the optical fiber 12. The second end 22 of the cap 16 is closed, whereby the sensor substance 13 is sealingly enclosed in the cap 16.

According to an embodiment, the optical fiber 12 and the cap 16 are all-glass components, for instance using silica. Accordingly, the optical fiber 12 may be fusion spliced to the cap 16 in the manner illustrated in FIG. 1, whereby no bonding agent is required therebetween. In this embodiment, the fiber-optic temperature sensor assembly 10 is mainly fused silica. As a result, the fiber-optic temperature sensor assembly 10 has a matched coefficient of thermal expansion.

As an example, it is considered to use the optical fiber 12 and capillary 16 having the range of dimensions set forth below for the temperature sensor assembly 10: optical fiber 12 at 50/125 μm, the cap 16 at 75/175 μm and 50/125 μm; also, the optical fiber 12 at 105/125 μm for the cap 16 at 150/350 μm.

Although not shown, the optical fiber 12 may be covered with a jacket of protective material, such as polyimide or PTFE. The protective material (if needed) is selected as a function of the contemplated use of the temperature sensor assembly 10.

The cap 16 is typically a capillary having the end 22 being collapsed or closed by way of a plug. In the instance of a plug, the plug may also be a glass plug that is compatible with a remainder of the cap 16 for fusion splicing.

Referring to FIGS. 2A to 2D, a sequence of operations is illustrated for the manufacture of the fiber optic temperature sensor assembly 10 of FIG. 1.

In FIG. 2A, there is provided the cap 16. It is observed in FIG. 2A that the cap 16 has both ends opened. The cap 16 may be cut or cleaved to suitable dimensions.

In FIG. 2B, the sensor end 14 of the optical fiber 12 is inserted in the inner cavity 18 of the cap 16. As mentioned above, the optical fiber 12 and the cap 16 may be of the same material and thus fused or fusion spliced to achieve the configuration of FIG. 2B. In order to perform the fusion splicing, it is considered to use a commercial fusion splice apparatus or CO₂ laser. As an alternative, the cap 16 may be collapsed onto the sensor end 14 of the optical fiber 12.

In FIG. 2C, the sensor substance 13 is inserted in the inner cavity 18 of the cap 16. The insertion of the sensor substance 13 is typically performed by the micro encapsulation of a minute amount of the substance (e.g., fluorophore) in the inner cavity 18. For instance, it is considered to use mechanical pressure on the sensor substance 13 to ensure that the sensor substance 13 is lodged in the inner cavity 18.

In FIG. 2D, the second end 22 of the cap 16 is closed. According to one embodiment, the second end 22 is collapsed to seal the inner cavity 18 shut as illustrated in FIG. 2D. According to another embodiment, a plug (e.g., a piece of optical fiber) is used to close the second end 22. The plug may then be fusion spliced to close off the second end 22. In such a case, precautions are taken to keep the sensor substance 13 at a given distance from the fusion spliced zone during the fusion splicing to avoid exposing the sensor substance 13 to heat. It may be required to cut off an excess portion of the cap 16 after FIG. 2D, for example to facilitate the thermal contact between the sensor substance 13 and the measured environment. For instance a cleavage process may be used to remove an excess portion.

A specific sequence of steps is illustrated following FIGS. 2A to 2D, it is pointed out that a different sequence may be performed. For instance, the second end 22 of the cap 16 may be closed prior to the insertion of the sensor substance 13 therein, or prior to the connection with the optical fiber 12 (with the sensor substance 13 already in the cap 16). According to an embodiment, once the sensor substance 13 is inserted in the capillary, the capillary 16 may be cleaved so as to have a proper length (e.g. reduced cavity thickness) prior to the insertion of the optical fiber 12 therein. If the end 22 is cleaved with the sensor substance 13 enclosed in the cap 16, the fusion of the optical fiber 12 to the cap 16 at the end 20 is performed at a suitable minimum distance from the sensor substance 13 so as not to damage the sensor substance 13 with the heat released by the fusion step.

The fused silica embodiment of the fiber-optic temperature sensor assembly 10 is well suited for extreme temperature range measurements, such as cryogenics, nuclear, microwave, strong RF applications, patient monitoring under MRI or intense electromagnetic field, aerospace applications and direct winding temperature measurements in high voltage transformers, among other possibilities. The temperature range of the fiber-optic temperature sensor assembly 10 will be dependent on the types of sensor substances 13 used. The temperature sensor assembly 10 may be used for long fiber link at extreme temperatures.

1. A fiber-optic temperature sensor assembly comprising:
a glass cap with an inner cavity;
a sensor substance received loosely in the inner cavity of the cap, the sensor substance having light-producing properties adapted to change with specific temperature variations; and
a glass optical fiber having a first end received in the inner cavity of the cap and fused without adhesive to the cap, and a second end of the optical fiber being adapted to be connected to a processing unit for transmitting light signals from the sensor substance to the processing unit when the fiber-optic temperature sensor assembly is subjected to specific temperatures.

2. The fiber-optic temperature sensor assembly according to claim 1, wherein the sensor substance is a fluorophore in a granular or powdery state.

3. The fiber-optic temperature sensor assembly according to claim 2, wherein the fluorophore powder is one of Mg4FGeO6:Mn and LuPO4:Dy.

4. The fiber-optic temperature sensor assembly according to claim 1, wherein the cap and the optical fiber are fusion spliced.

5. The fiber-optic temperature sensor assembly according to claim 1, wherein the cap is a capillary.

6. The fiber-optic temperature sensor assembly according to claim 5, wherein an end of the capillary away from the optical fiber is collapsed to sealingly close the inner cavity.

7. The fiber-optic temperature sensor assembly according to claim 5, wherein an end of the capillary away from the optical fiber is sealingly closed with a plug fused to the capillary.

8. A method for manufacturing a fiber-optic temperature sensor assembly comprising:
fusing without adhesive a first end of a glass cap having an inner cavity to an end of a glass optical fiber;
inserting a sensor substance having light-emitting properties adapted to change with temperature variations into the inner cavity of the cap; and
closing a second end of the cap to seal the sensor substance in the inner cavity of the cap.

9. The method according to claim 8, securing without adhesive the cap to the optical fiber comprises fusion splicing the cap to the optical fiber.

10. The method according to claim 8, comprising sequentially performing the securing, the inserting and the closing.

11. The method according to claim 8, wherein closing the second end of the cap comprises collapsing the second end of the cap.

12. The method according to claim 8, wherein closing the second end of the cap comprises fusing a plug in the second end of the cap.

13. The method according to claim 8, wherein inserting the sensor substance comprises mechanically pressuring the sensor substance in the inner cavity.

14. The method according to claim 8, further comprising cleaving the cap to reduce a cavity thickness or sensor length.
